(19) United States
(12) Patent Application Publication
(10) Pub. No.: US 2025/0216882 A1
(43) Pub. Date: Jul. 3, 2025

(54) LDO POWER SUPPLY REJECTION RATIO IMPROVEMENT WITH SIMPLE FEED-FORWARD RIPPLE CANCELLATION TECHNIQUE

(71) Applicant: MEDIATEK INC., Hsinchu City (TW)

(72) Inventors: Chen-Han Tsai, Hsinchu City (TW); Chih-Hou Tsai, Hsinchu City (TW)

(73) Assignee: MEDIATEK INC., Hsinchu City (TW)

(21) Appl. No.: 19/002,735

(22) Filed: Dec. 27, 2024

Related U.S. Application Data
(60) Provisional application No. 63/614,961, filed on Dec. 27, 2023.

(51) Int. Cl. G05F 1/575

(52) U.S. Cl. CPC G05F 1/575

(57) ABSTRACT

The present invention provides a voltage regulator configured to receive a supply voltage to generate a regulated voltage. The voltage regulator comprises an operation amplifier and a power transistor. The operational amplifier is configured to receive a reference voltage and a feedback signal to generate an output signal. The power transistor is coupled to the operational amplifier, wherein a gate electrode receives the output signal of the operational amplifier, a first electrode is coupled to the supply voltage, and a second electrode is used to generate the regulated voltage. The operational amplifier comprises an input stage, a current source and a capacitor, wherein the current source with the capacitor are configured to provide an AC current to the gate electrode of the power transistor for ripple cancellation.

### CROSS REFERENCE TO RELATED APPLICATIONS

This application claims the benefit of U.S. Provisional Application No. 63/614,961, filed on Dec. 27, 2023. The content of the application is incorporated herein by reference.

### BACKGROUND

Voltage regulators are used in a variety of systems to provide a regulated voltage to other circuits in the system. Generally, it is desirable to provide a stable regulated voltage in the face of a wide variety of loads, operating frequencies, etc. In other words, a voltage regulator is designed to provide and maintain a constant voltage in electrical applications, wherein a low dropout (LDO) voltage regulator is a DC linear voltage regulator which has a very small input-output differential voltage and relatively low output noise.

A measure of the effectiveness of a voltage regulator is its power supply rejection ratio (PSRR), which measures a ratio of the change in supply voltage to the equivalent output voltage. The input voltage of the LDO typically comes from a switched regulator where the switching noise is generally tens of millivolts. Therefore, how to have the better PSRR is an important topic.

### SUMMARY

It is therefore an objective of the present invention to provide a LDO, which can use a simple feed-forward ripple cancellation (FFRC) technique in the LDO to greatly improve the PSRR, to solve the above-mentioned problems.

According to one embodiment of the present invention, a voltage regulator configured to receive a supply voltage to generate a regulated voltage is disclosed. The voltage regulator comprises an operation amplifier and a power transistor. The operational amplifier is configured to receive a reference voltage and a feedback signal to generate an output signal. The power transistor is coupled to the operational amplifier, wherein a gate electrode receives the output signal of the operational amplifier, a first electrode is coupled to the supply voltage, and a second electrode is used to generate the regulated voltage. The operational amplifier comprises an input stage, a current source and a capacitor. The input stage is configured to receive the reference voltage and the feedback signal. The current source is coupled to the input stage, wherein the current source comprises a first transistor and a second transistor, source electrodes of the first transistor and the second transistors are coupled to the supply voltage, gate electrodes of the first transistor and the second transistors are connected together, a drain electrode and the gate electrode of the first transistor are connected together at a connection node, and a drain electrode of the second transistor is coupled to the gate electrode of the power transistor. The capacitor is coupled between the connection node and a ground voltage.

According to one embodiment of the present invention, a voltage regulator configured to receive a supply voltage to generate a regulated voltage is disclosed. The voltage regulator comprises an operational amplifier, a power transistor and a current generator. The operational amplifier is configured to receive a reference voltage and a feedback signal to generate an output signal. The power transistor is coupled to the operational amplifier, wherein a gate electrode receives the output signal of the operational amplifier, a first electrode is coupled to the supply voltage, and a second electrode is used to generate the regulated voltage. The current generator comprises a first transistor, a second transistor and a capacitor, wherein source electrodes of the first transistor and the second transistors are coupled to the supply voltage, gate electrodes of the first transistor and the second transistors are connected together, a drain electrode and the gate electrode of the first transistor are connected together at a connection node, a drain electrode of the second transistor is coupled to the gate electrode of the power transistor, and the capacitor is coupled between the connection node and a ground voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a LDO regulator according to one embodiment of the present invention.

FIG. 2 is a diagram showing the ripple cancellation operation of the LDO.

FIG. 3 is a diagram illustrating a LDO regulator according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

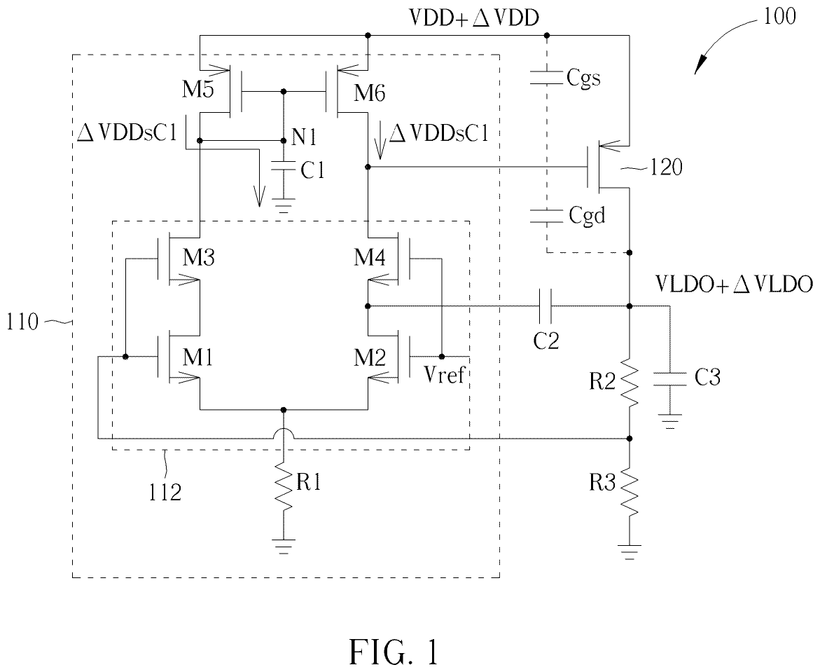

FIG. 1 is a diagram illustrating a LDO regulator 100 according to one embodiment of the present invention. The LDO regulator 100 is configured to receive a supply voltage VDD to generate a regulated voltage VLDO. As shown in FIG. 1, the LDO regulator 100 comprises an operational amplifier 110, a power transistor 120, capacitors C2, C3, and two resistors R2 and R3. The operational amplifier 110 comprises an input stage 112, a current source, and a resistor R1. The input stage 112 comprises transistors M1-M4 which are implemented by using N-type Metal Oxide Semiconductor Field Effect Transistors (MOSFETs), wherein a source electrode of the transistor M1 is coupled to a ground voltage via the resistor R1, a drain electrode of transistor M1 is coupled to a source electrode of the transistor M3, a drain electrode of the transistor M3 is coupled to the current source, and gate electrodes of the transistors M1 and M3 receive a feedback signal generated according to the regulated voltage VLDO (e.g., the feedback signal is generated by using the resistors R2 and R3 to divide the regulated voltage VLDO. A source electrode of the transistor M2 is coupled to the ground voltage via the resistor R1, a drain electrode of transistor M2 is coupled to a source electrode of the transistor M4, a drain electrode of the transistor M4 is coupled to the current source, and gate electrodes of the transistors M2 and M4 receive a reference voltage Vref. The current source comprises transistors M5 and M6 which are implemented by using P-type MOSFETs. A source electrode of the transistor M5 is coupled to the supply voltage VDD, a drain electrode of the transistor M5 is coupled to the drain electrode of the transistor M3, and the transistor M5 is configured to provide a current (DC current) to the transistors M3 and M1. A source electrode of the transistor M6 is coupled to the supply voltage VDD, a drain electrode of the transistor M6 is coupled to the drain electrode of the transistor M4, and the transistor M6 is configured to provide a current (DC current) to the transistors M4 and M2. The power transistor 120 is implemented by using a P-type MOSFET, wherein a gate electrode is coupled to an output terminal of the operational amplifier 110 (i.e., the drain electrode of the transistor M4) to receive an output signal of the operational amplifier 110, a source electrode is coupled to the supply voltage, and a drain electrode serves as an output terminal of the LDO regulator 100.

It is noted that the detailed circuit structure of the operational amplifier 110 is for illustrative, not a limitation of the present invention.

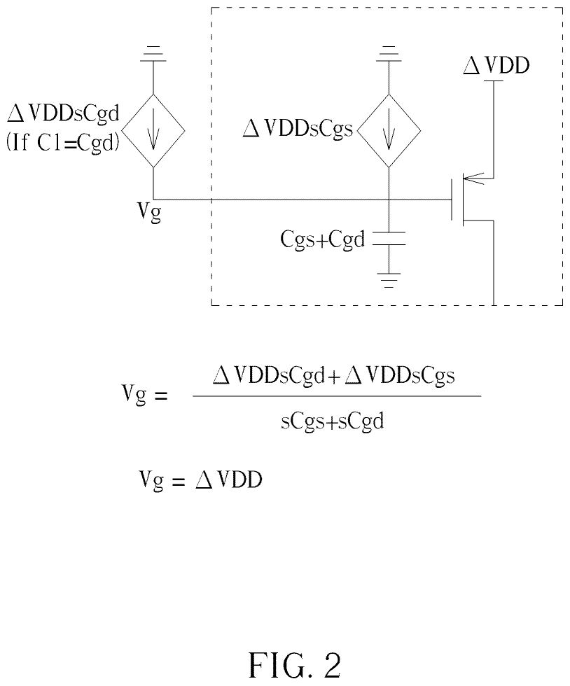

The LDO regulator 100 may receive the supply voltage VDD with a supply voltage ripple ΔVDD, and the supply voltage ripple ΔVDD may cause the regulated voltage VLDO to have an output ripple ΔVLDO, resulting in worse PSRR. In order to cancel the output ripple ΔVLDO, a small signal at the gate electrode of the power transistor 120 needs to be equal to the supply voltage ripple ΔVDD, to make the gate-to-source voltage (small signal) equal to zero to avoid the output ripple ΔVLDO. Referring to FIG. 1 and FIG. 2 together, the gate-drain capacitance Cgd and gate-source capacitance Cgs can be regarded as a voltage divider, and small signal “vg” at the gate electrode of the power transistor 120 can be described by equation (1):

$$v g = Δ V DD \frac{\frac{1}{sCgd}}{\frac{1}{s C g d} + \frac{1}{s C g s}} = \frac{Δ V DD sCgs}{s ( Cgs + Cgd )} . \qquad ( 1 )$$

The symbol “s” in the equation (1) is Laplace operator. As shown in the equation (1), the gate-drain capacitance Cgd and gate-source capacitance Cgd of the power transistor 120 can be modeled as a current source (ΔVDDsCgs) with a capacitor (Cgs+Cgd).

In order to make the small signal “vg” at the gate electrode of the power transistor 120 to be equal to the supply voltage ripple ΔVDD, the embodiment of FIG. 1 designs a capacitor C1 with the current source of the operational amplifier 110, wherein the capacitor C1 is coupled between a node N1 and the ground voltage, and the node N1 is a connection node between the gate electrode and the drain electrode of the transistor M5 (i.e., the transistor M5 is a diode connected P-type transistor). Specifically, because the transistor M5 has small impedance while the input stage 112 can be regarded as a very large impedance, the small signal at the gate electrode of the transistors M5 and M6 are much similar to the supply voltage ripple ΔVDD, and the current (AC current) flowing from the transistor M5 to the ground via the capacitor C1 will be equal to “ΔVDDsC1”. In addition, the mirrored current (AC current) flowing through the transistor M6 will also be “ΔVDDSC1”.

In addition, the capacitor C1 shown in FIG. 1 can be implemented by any type of capacitor, such as a passive capacitor or a metal-oxide-semiconductor capacitor.

Referring to FIG. 2, if the capacitor C1 is designed to have the capacitance equal to the gate-drain capacitance Cgd of the power transistor 120, the small signal “vg” at the gate electrode of the power transistor 120 will be described by equation (2):

$$v g = \frac{Δ V DDsCgs + Δ V DDsCgd}{s ( C g s + C g d )} = Δ V DD . \qquad ( 2 )$$

In the above embodiment shown in FIG. 1 and FIG. 2, by adding the capacitor C1 in the current mirror of the operational amplifier 110, a simple feed-forward ripple cancellation (FFRC) technique is implemented to stabilize the regulated voltage VLDO.

In this embodiment, the capacitor C2 may have larger capacitance for phase margin compensation.

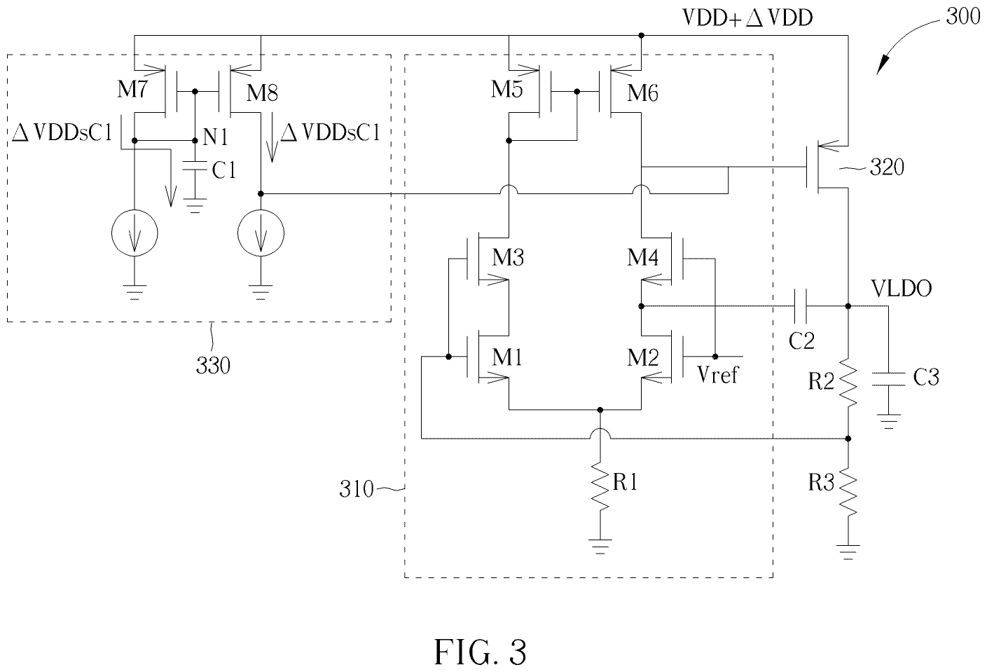

FIG. 3 is a diagram illustrating a LDO regulator 300 according to one embodiment of the present invention. The LDO regulator 300 is configured to receive a supply voltage VDD to generate a regulated voltage VLDO. As shown in FIG. 3, the LDO regulator 300 comprises an operational amplifier 310, a power transistor 320, a current generator 330, capacitors C2, C3, and two resistors R2 and R3. The operational amplifier 310 comprises an input stage, a current source, and a resistor R1. The input stage comprises transistors M1-M4 which are implemented by using N-type MOSFETs, wherein a source electrode of the transistor M1 is coupled to a ground voltage via the resistor R1, a drain electrode of transistor M1 is coupled to a source electrode of the transistor M3, a drain electrode of the transistor M3 is coupled to the current source, and gate electrodes of the transistors M1 and M3 receive a feedback signal generated according to the regulated voltage VLDO (e.g., the feedback signal is generated by using the resistors R2 and R3 to divide the regulated voltage VLDO. A source electrode of the transistor M2 is coupled to the ground voltage via the resistor R1, a drain electrode of transistor M2 is coupled to a source electrode of the transistor M4, a drain electrode of the transistor M4 is coupled to the current source, and gate electrodes of the transistors M2 and M4 receive a reference voltage Vref. The current source comprises transistors M5 and M6 which are implemented by using P-type MOSFETs. A source electrode of the transistor M5 is coupled to the supply voltage VDD, a drain electrode of the transistor M5 is coupled to the drain electrode of the transistor M3, and the transistor M5 is configured to provide a current to the transistors M3 and M1. A source electrode of the transistor M6 is coupled to the supply voltage VDD, a drain electrode of the transistor M6 is coupled to the drain electrode of the transistor M4, and the transistor M6 is configured to provide a current to the transistors M4 and M2. The power transistor 120 is implemented by using a P-type MOSFET, wherein a gate electrode is coupled to an output terminal of the operational amplifier 310 (i.e., the drain electrode of the transistor M4), a source electrode is coupled to the supply voltage, and a drain electrode serves as an output terminal of the LDO regulator 300.

It is noted that the detailed circuit structure of the operational amplifier 310 is for illustrative, not a limitation of the present invention.

The current generator 330 comprises transistors M7, M8 and a capacitor C1, wherein the capacitor C1 can be implemented by any type of capacitor, such as a passive capacitor or a metal-oxide-semiconductor capacitor. The transistors M7 and M8 are implemented by P-type MOSFETs, wherein a source electrode of the transistor M7 is coupled to the supply voltage VDD, a drain electrode of the transistor M7 is coupled to the ground voltage, gate electrodes of the transistors M7 and M8 are connected together, a source electrode of the transistor M8 is coupled to the supply voltage VDD, and a drain electrode of the transistor is coupled to the gate electrode of the power transistor 320. In addition, the capacitor C1 is coupled between a node N1 and the ground voltage, and the node N1 is a connection node between the gate electrode and the drain electrode of the transistor M7 (i.e., the transistor M7 is a diode connected P-type transistor). Specifically, because the transistor M7 has small impedance while a current source coupled between the transistor M7 and the ground voltage can be regarded as a very large impedance, the small signal at the gate electrode of the transistors M7 and M8 are much similar to the supply voltage ripple ΔVDD, and the current (AC current) flowing from the transistor M7 to the ground via the capacitor C1 will be equal to “ΔVDDsC1”. In addition, the mirrored current (AC current) flowing through the transistor M8 will also be “ΔVDDSC1”.

Similar to the embodiment shown in FIG. 2, if the capacitor C1 is designed to have the capacitance equal to the gate-drain capacitance Cgd of the power transistor 320, by using the current generator 330 to provide the current (AC current) “ΔVDDsCgd” to the gate electrode of the power transistor 320, the small signal “vg” at the gate electrode of the power transistor 120 will be described by the above equation (2), that is vg=ΔVDD.

In the above embodiment shown in FIG. 1 and FIG. 2, by using the current generator 330 capable of provide the current “ΔVDDsCgs” to the gate electrode of the power transistor 320, a simple feed-forward ripple cancellation technique is implemented to stabilize the regulated voltage VLDO.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voltage regulator, configured to receive a supply voltage to generate a regulated voltage, and the voltage regulator comprises:
an operational amplifier, configured to receive a reference voltage and a feedback signal to generate an output signal; and
a power transistor, wherein a gate electrode receives the output signal of the operational amplifier, a first electrode is coupled to the supply voltage, and a second electrode is used to generate the regulated voltage;
wherein the operational amplifier comprises:
an input stage, configured to receive the reference voltage and the feedback signal;
a current source, coupled to the input stage, wherein the current source comprises a first transistor and a second transistor, source electrodes of the first transistor and the second transistors are coupled to the supply voltage, gate electrodes of the first transistor and the second transistors are connected together, a drain electrode and the gate electrode of the first transistor are connected together at a connection node, and a drain electrode of the second transistor is coupled to the gate electrode of the power transistor; and
a capacitor, coupled between the connection node and a ground voltage.

2. The voltage regulator of claim 1, wherein capacitance of the capacitor is equal to gate-drain capacitance of the power transistor.

3. The voltage regulator of claim 2, wherein a current flowing through the first transistor and the capacitor is equal to “ΔVDDsC1”, and the second transistor provides a mirrored current “ΔVDDsC1” to the gate electrode of the power transistor, wherein “ΔVDD” is a supply voltage ripple, “s” is Laplace operator, and “Cgs” is the capacitance of the capacitor.

4. The voltage regulator of claim 1, wherein the power transistor is a P-type Metal Oxide Semiconductor Field Effect Transistors (MOSFET).

5. A voltage regulator, configured to receive a supply voltage to generate a regulated voltage, and the voltage regulator comprises:
an operational amplifier, configured to receive a reference voltage and a feedback signal to generate an output signal;
a power transistor, wherein a gate electrode receives the output signal of the operational amplifier, a first electrode is coupled to the supply voltage, and a second electrode is used to generate the regulated voltage; and
a current generator comprising a first transistor, a second transistor and a capacitor, wherein source electrodes of the first transistor and the second transistors are coupled to the supply voltage, gate electrodes of the first transistor and the second transistors are connected together, a drain electrode and the gate electrode of the first transistor are connected together at a connection node, a drain electrode of the second transistor is coupled to the gate electrode of the power transistor, and the capacitor is coupled between the connection node and a ground voltage.

6. The voltage regulator of claim 5, wherein capacitance of the capacitor is equal to gate-drain capacitance of the power transistor.

7. The voltage regulator of claim 6, wherein a current flowing through the first transistor and the capacitor is equal to “ΔVDDsC1”, and the second transistor provides a mirrored current “ΔVDDsC1” to the gate electrode of the power transistor, wherein “ΔVDD” is a supply voltage ripple, “s” is Laplace operator, and “Cgs” is the capacitance of the capacitor.

8. The voltage regulator of claim 5, wherein the power transistor is a P-type Metal Oxide Semiconductor Field Effect Transistors (MOSFET).
